(19) United States
(12) Patent Application Publication
(10) Pub. No.: US 2007/0176851 A1
(43) Pub. Date: Aug. 2, 2007

(54) Projection display with motion compensation

(76) Inventors: Stephen R. Willey, Bellevue, WA (US); Randall B. Sprague, Crnation, WA (US); Christopher A. Wiklof, Everett, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 11/635,799

(22) Filed: Dec. 6, 2006

Related U.S. Application Data
(60) Provisional application No. 60/742,638, filed on Dec. 6, 2005.

(51) Int. Cl. G09G 3/00

(52) U.S. Cl. 345/32

(57) ABSTRACT

A control system for a projection display includes means for compensating for relative movement between a projection display and a projection surface and/or between a projected image and a viewer. The system may compensate for image shake. Movement may be detected optically, through motion or inertial detection, etc. The image may be compensated by modifying image properties such as resolution, by modifying an image bitmap, by moving a display engine or a display engine component, and/or by deflecting the projection axis, for example. According to an embodiment the projection display may include a display engine utilizing a laser scanner.

### CROSS REFERENCE TO RELATED APPLICATIONS

The present application claims priority benefit from and incorporates by reference herein U. S. Provisional application Ser. No. 60/742,638 entitled PROJECTION DISPLAY WITH MOTION COMPENSATION, filed Dec. 6, 2005.

### TECHNICAL FIELD

The present disclosure relates to projection displays, and especially to projection displays with control systems and/or actuators that improve stability of the displayed image.

### BACKGROUND

In the field of projection displays, it is often desirable to ensure a solid mechanical mounting of the display projector. Such a solid mounting may reduce or eliminate movement of a projected image relative to a projection screen.

FIG. 1 is a diagram showing the operation of a display system 101 without image stabilization enabled according to the prior art. A projection display 102 at a first position projects an image along an axis 104 onto a surface 106 with the image having an extent 108. The image may be seen by a viewer's eye 110. At another instant in time, the projection display may be moved to a second position or a second projection display may be enabled at the second position. The projection display at the second position is denoted 102′. With no compensation, the projection display 102′ projects an image along the axis 104′ to create a visible displayed image having an extent 108′. Depending upon the rapidity of movement from position 102 to 102′, offset distance between displayed image extents 108 and 108′, display resolution, image content, etc., the resultant video image may be difficult or tiresome for the viewer's eye 110 to watch and receive information.

### OVERVIEW

One aspect according to the invention relates to methods and apparatuses for compensating for movement of a projection display apparatus.

According to an embodiment, one or more parameters correlated to movement of a projected image relative to a projection surface and/or a viewer is measured. A projection display modifies the mean axis of projected pixels so as to reduce or substantially eliminate perceived movement of the projected image. Thus, instabilities in the way the pixels are projected onto a display screen are compensated for and the perceived image quality may be improved.

According to an embodiment, a video image of the projection surface is captured by an image projection device. Apparent movement of the projection surface relative to the projected image is measured. The projected image may be adjusted to compensate for the apparent movement of the projection surface. According to an embodiment, the projected image may be stabilized relative to the projection surface.

According to an embodiment, one or more motion sensors are coupled to an image projection device. A signal from the one or more motion sensors is received. The projected image may be adjusted to compensate for the apparent motion of the projection device.

According to an embodiment, a projection display projects a sequence of video frames along one or more projection axes. A sequence of image displacements is detected. A model is determined to predict future image displacements. The projection axis may be modified in anticipation of the future image displacements.

According to an embodiment, an optical path of an image projection device includes a projection axis modification device. A signal may be received from a controller indicating a desired modification of the projection axis. An actuator modifies the projection axis to maintain a stable projected image.

According to an embodiment, an image projection device includes a first pixel forming region that is somewhat smaller than a second available pixel forming region. The portion of possible pixel forming locations that falls outside the nominal video projection area (i.e. the first pixel forming region) provides room to move the first pixel forming region relative to the second pixel forming region. A signal may be received from a controller indicating a desired modification of the pixel projection area. Pixels are mapped to differing pixel formation locations to maintain a stable projected image. Alternatively, the first pixel-forming region may be substantially the same size, or even smaller than, the second available pixel forming area. In the alternative embodiment, pixels mapped outside the second pixel forming area are not displayed.

According to an embodiment the projection display comprises a scanned beam display or other display that sequentially forms pixels.

According to another embodiment the projection display comprises a focal plane image source such as a liquid crystal display (LCD), micromirror array display, liquid crystal on silicon (LCOS) display, or other image source that substantially simultaneously forms pixels.

According to an embodiment, a beam scanner (in the case of a scanned beam display engine) or focal plane image source may be mounted on or include an actuation system to vary the relationship of at least a portion of the display engine relative to a nominal image projection axis. A signal may be received from a controller indicating a desired modification of the projection path. An actuator modifies the position of at least a portion of the display engine to vary the projection axis. A stable projected image may be maintained.

According to one embodiment, a focal plane detector such as a CCD or CMOS detector is used as a projection surface property detector to detect projection surface properties. A series of images of the projection surface may be collected. The series of images may be collected to determine relative motion between the projection surface and the projection display. Detected movement of the projection display with respect to the projection surface may be used to calculate a projection axis correction.

According to an embodiment, a non-imaging detector such as a photodiode including a positive-intrinsic-negative (PIN) photodiode, phototransistor, photomultiplier tube (PMT) or other non-imaging detector is used as a screen property detector to detect screen properties. According to some embodiments, a field of view of a non-imaging detector may be scanned across the display field of view to determine positional information.

According to an embodiment, a displayed image monitoring system may sense the relative locations of projected pixels. The relative locations of the projected pixels may then be used to adjust the displayed image to project a more optimum distribution of pixels. According to one embodiment, optimization of the projected location of pixels may be performed substantially continuously during a display session.

According to an embodiment, a projection display may sense an amount of image shake and adjust displayed image properties to accommodate the instability.

### BRIEF DESCRIPTION OF THE DRAWINGS

FIG. 1 is a diagram showing the operation of a display system without image stabilization enabled.

FIG. 2 is a diagram showing the operation of a display system with image stabilization enabled according to an embodiment.

FIG. 3 is a block diagram of a projection display with image stabilization according to an embodiment.

FIG. 4 is a block diagram showing electrical connections between an inertial measurement unit-type sensor and controller in a projection display according to an embodiment.

FIG. 5 is a flow chart illustrating a method for modifying an image projection axis based on data received from an orientation sensor according to an embodiment.

FIG. 6 is a block diagram of a projection display that includes a backscattered light sensor according to an embodiment.

FIG. 7 is a diagram illustrating the detection of a relative location parameter for a projection surface using a backscattered light detector according to an embodiment.

FIG. 8 is a simplified diagram illustrating a sequential process for projecting pixels and measuring a projection surface response according to an embodiment.

FIG. 9 is a simplified diagram of projection surface showing the tracking of image position variations and compensation according to an embodiment.

FIG. 10 illustrates the fitting of historical projection axis motion to a curve to derive a modified projection axis in anticipation of future motion according to an embodiment.

FIG. 11 is a simplified block diagram of some relevant subsystems of a projection display having image stability compensation according to an embodiment.

FIG. 12 is a diagram of a projection display using actuated adaptive optics to vary the projection axis according to an embodiment.

FIG. 13A is a cross-sectional diagram of an integrated X-Y light deflector according to an embodiment.

FIG. 13B is an exploded diagram of an integrated X-Y light deflector according to an embodiment.

FIG. 14 is a block diagram illustrating the relationship of major components of an image stability-compensating display controller according to an embodiment.

FIG. 15 is a graphical depiction of a portion of a bitmap memory showing offset pixel locations according to an embodiment.

FIG. 16 illustrates a beam scanner with capability for being tilted to modify the projection axis.

FIG. 17 is a perspective drawing of an exemplary portable projection system with screen compensation according to an embodiment.

FIG. 18 is a flow chart showing a method for making adjustments to projection display and/or image parameters responsive to image instability according to an embodiment.

### DETAILED DESCRIPTION

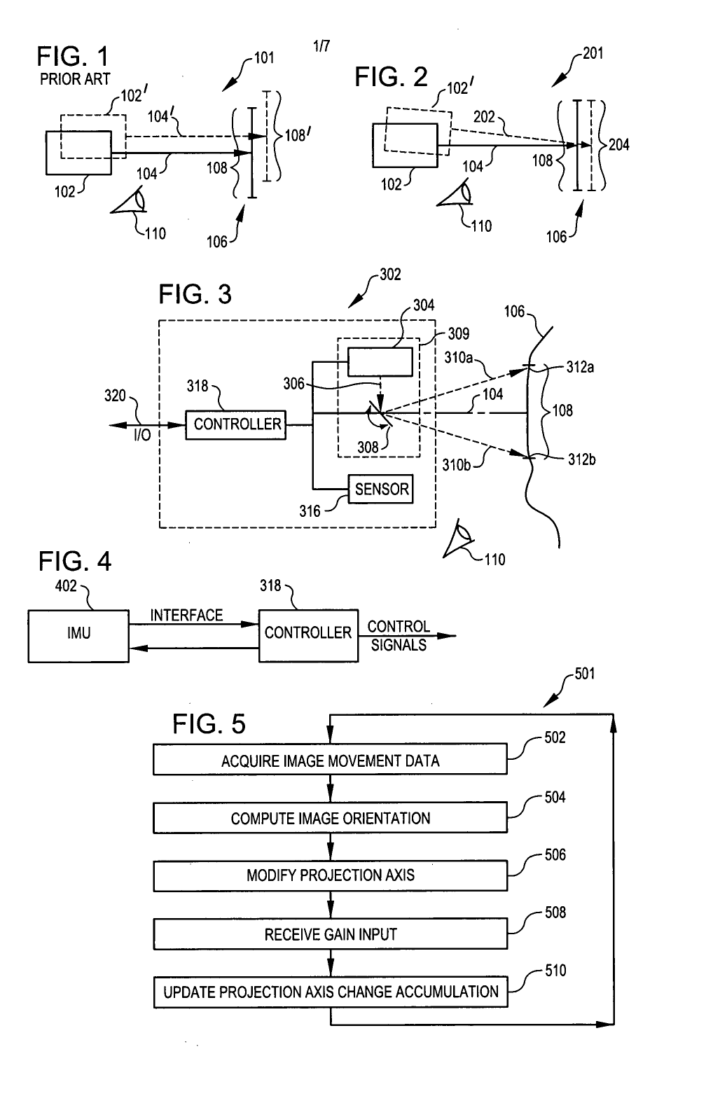

FIG. 2 is a diagram showing the operation of a display system 201 with image stabilization enabled according to an embodiment. As in FIG. 1, a projection display 102 at a first position projects an image along an axis 104 onto a surface 106 with the image having an extent 108. The image may be seen by a viewer's eye 110. At another instant in time, the projection display may be moved to a second position or a second projection display may be enabled at the second position. The projection display at the second position is denoted 102′. The movement of the projection display system at position 102 to the projection display system at 102′ may be sensed according to various embodiments. In response, the projection display system at 102′ projects an image along an axis 202. The axis 202 may be selected to create a displayed image extent 204 that is substantially congruent with the displayed image extent 108. The axis 202 for image projection may be selected according to various embodiments. While the axis 202 is shown having an angle relative to the first projection axis 104, various embodiments may allow the compensated axis 202 to be substantially coaxial with the first axis 104. Because the compensated projected image 204 is substantially congruent with the projected image 108, image quality is improved and the viewer's eye 110 may be able to perceive a more stable image that has improved quality.

FIG. 3 is a block diagram of an exemplary projection display apparatus 302 with a capability for displaying an image on a surface 106, according to an embodiment. An input video signal, received through interface 320 drives a controller 318. The controller 318, in turn, drives a projection display engine 309 to project an image along an axis 104 onto a surface 106, the image having an extent 108.

The projection display engine 309 may be of many types including a transmissive or reflective liquid crystal display (LCD), liquid-crystal-on-silicon (LCOS), a deformable mirror device array (DMD), a cathode ray tube (CRT), etc. The illustrative example of FIG. 3 includes a scanned beam display engine 309.

In the projection display 302, the controller sequentially drives an illuminator 304 to a brightness corresponding to pixel values in the input video signal while the controller 318 simultaneously drives a scanner 308 to sequentially scan the emitted light. The illuminator 304 creates a first modulated beam of light 306. The illuminator 304 may, for example, comprise red, green, and blue modulated lasers combined using a combiner optic to form a beam shaped with a beam shaping optical element. A scanner 308 deflects the first beam of light across a field-of-view (FOV) as a second scanned beam of light 310. Taken together, the illuminator 304 and scanner 308 comprise a scanned beam display engine 309. Instantaneous positions of scanned beam of light 310 may be designated as 310a, 310b, etc. The scanned beam of light 310 sequentially illuminates spots 312 in the FOV, the FOV comprising a display surface or projection screen 106. Spots 312a and 312b on the projection screen are illuminated by the scanned beam 310 at positions 310a and 310b, respectively. To display an image, spots corresponding to substantially all the pixels in the received video image are sequentially illuminated, nominally with an amount of power proportional to the brightness of the respective video image pixel.

The light source or illuminator 304 may include multiple emitters such as, for instance, light emitting diodes (LEDs), lasers, thermal sources, arc sources, fluorescent sources, gas discharge sources, or other types of illuminators. In one embodiment, illuminator 304 comprises a red laser diode having a wavelength of approximately 635 to 670 nanometers (nm). In another embodiment, illuminator 304 comprises three lasers; a red diode laser, a green diode-pumped solid state (DPSS) laser, and a blue DPSS laser at approximately 635 nm, 532 nm, and 473 nm, respectively. While some lasers may be directly modulated, other lasers, such as DPSS lasers for example, may require external modulation such as an acousto-optic modulator (AOM) for instance. In the case where an external modulator is used, it is considered part of light source 304. Light source 304 may include, in the case of multiple emitters, beam combining optics to combine some or all of the emitters into a single beam. Light source 304 may also include beam-shaping optics such as one or more collimating lenses and/or apertures. Additionally, while the wavelengths described in the previous embodiments have been in the optically visible range, other wavelengths may be within the scope.

Light beam 306, while illustrated as a single beam, may comprise a plurality of beams converging on a single scanner 308 or onto separate scanners 308.

Scanner 308 may be formed using many technologies such as, for instance, a rotating mirrored polygon, a mirror on a voice-coil as is used in miniature bar code scanners such as used in the Symbol Technologies SE 900 scan engine, a mirror affixed to a high speed motor or a mirror on a bimorph beam as described in U.S. Pat. No. 4,387,297 entitled PORTABLE LASER SCANNING SYSTEM AND SCANNING METHODS, an in-line or “axial” gyrating, or “axial” scan element such as is described by U.S. Pat. No. 6,390,370 entitled LIGHT BEAM SCANNING PEN, SCAN MODULE FOR THE DEVICE AND METHOD OF UTILIZATION, a non-powered scanning assembly such as is described in U.S. patent application Ser. No. 10/007,784, SCANNER AND METHOD FOR SWEEPING A BEAM ACROSS A TARGET, commonly assigned herewith, a MEMS scanner, or other type. All of the patents and applications referenced in this paragraph are hereby incorporated by reference

A MEMS scanner may be of a type described in U.S. Pat. No. 6,140,979, entitled SCANNED DISPLAY WITH PINCH, TIMING, AND DISTORTION CORRECTION; U.S. Pat. No. 6,245,590, entitled FREQUENCY TUNABLE RESONANT SCANNER AND METHOD OF MAKING; U.S. Pat. No. 6,285,489, entitled FREQUENCY TUNABLE RESONANT SCANNER WITH AUXILIARY ARMS; U.S. Pat. No. 6,331,909, entitled FREQUENCY TUNABLE RESONANT SCANNER; U.S. Pat. No. 6,362,912, entitled SCANNED IMAGING APPARATUS WITH SWITCHED FEEDS; U.S. Pat. No. 6,384,406, entitled ACTIVE TUNING OF A TORSIONAL RESONANT STRUCTURE; U.S. Pat. No. 6,433,907, entitled SCANNED DISPLAY WITH PLURALITY OF SCANNING ASSEMBLIES; U.S. Pat. No. 6,512,622, entitled ACTIVE TUNING OF A TORSIONAL RESONANT STRUCTURE; U.S. Pat. No. 6,515,278, entitled FREQUENCY TUNABLE RESONANT SCANNER AND METHOD OF MAKING; U.S. Pat. No. 6,515,781, entitled SCANNED IMAGING APPARATUS WITH SWITCHED FEEDS; U.S. Pat. No. 6,525,310, entitled FREQUENCY TUNABLE RESONANT SCANNER; and/or U.S. patent application Ser. No. 10/984,327, entitled MEMS DEVICE HAVING SIMPLIFIED DRIVE; for example; all hereby incorporated by reference.

In the case of a 1D scanner, the scanner may be driven to scan output beam 310 along a first dimension and a second scanner may be driven to scan the output beam 310 in a second dimension. In such a system, both scanners are referred to as scanner 308. In the case of a 2D scanner, scanner 308 may be driven to scan output beam 310 along a plurality of dimensions so as to sequentially illuminate pixels 312 on the projection surface 106.

For compact and/or portable display systems 302, a MEMS scanner is often preferred, owing to the high frequency, durability, repeatability, and/or energy efficiency of such devices. A bulk micro-machined or surface micro-machined silicon MEMS scanner may be preferred for some applications depending upon the particular performance, environment or configuration. Other embodiments may be preferred for other applications.

A 2D MEMS scanner 308 scans one or more light beams at high speed in a pattern that covers an entire projection extent 108 or a selected region of a projection extent within a frame period. A typical frame rate may be 60 Hz, for example. Often, it is advantageous to run one or both scan axes resonantly. In one embodiment, one axis is run resonantly at about 19 KHz while the other axis is run non-resonantly in a sawtooth pattern to create a progressive scan pattern. A progressively scanned bi-directional approach with a single beam, scanning horizontally at scan frequency of approximately 19 KHz and scanning vertically in sawtooth pattern at 60 Hz can approximate an SVGA resolution. In one such system, the horizontal scan motion is driven electrostatically and the vertical scan motion is driven magnetically. Alternatively, both the horizontal scan may be driven magnetically or capacitively. Electrostatic driving may include electrostatic plates, comb drives or similar approaches. In various embodiments, both axes may be driven sinusoidally or resonantly.

In some embodiments, the scanner 308 scans a region larger than an instantaneous projection extent 108. The illuminator 304 is modulated to project a video image across a region corresponding to a projection extent 108. When the controller 318 receives a signal from the sensor 316 indicating the projection extent has moved or determines that it is likely the projection extent will move to a new location 108′, the controller moves the portion of the instantaneous projection extent 108 to a different range within the larger region scanned by the scanner 308 such that the location of the projection extent remains substantially constant.

The projection display 302 may be embodied as monochrome, as full-color, or hyper-spectral. In some embodiments, it may also be desirable to add color channels between the conventional RGB channels used for many color displays. Herein, the term grayscale and related discussion shall be understood to refer to each of these embodiments as well as other methods or applications within the scope of the invention. In the control apparatus and methods, pixel gray levels may comprise a single value in the case of a monochrome system, or may comprise an RGB triad or greater in the case of color or hyperspectral systems. Control may be applied individually to the output power of particular channels (for instance red, green, and blue channels) or may be applied universally to all channels, for instance as luminance modulation.

A sensor 316 may be used to determine one or more parameters used in the stabilization the projected image. Such stabilization may include stabilization relative to the projection surface 106 and/or relative to the viewer's eye 110. According to one embodiment, the sensor 316 may be a motion detection subsystem, for example comprising one or more accelerometers, gyroscopes, coordinate measurement devices such as GPS or local positioning system receivers, etc. According to an illustrative embodiment, the sensor 316 may comprise one or more commercially-available orientation, distance, and/or motion sensors. One type of commercially-available motion sensor is an inertial measurement unit (IMU) manufactured by INTERSENSE, Inc. of Bedford, Mass. as model INERTIACUBE3.

According to an embodiment, an IMU is mounted at a fixed orientation with respect to the projection display. FIG. 4 is a block diagram showing electrical connections between an IMU 402 and controller 318. The interface can be one or more standard interfaces such as USB, serial, parallel, Ethernet, or firewire; or a custom electrical interface and data protocol. The communications link can be one-way or two-way. According to an embodiment, the interface is two-way, with the controller sending calibration and get data commands to the IMU, and the IMU sending a selected combination of position, orientation, velocity, and/or acceleration, and/or the derivatives of these quantities. Based upon changes in orientation sensed by the IMU (and optionally other input), the controller generates control signals used for modifying the projection axis of the projection display.

FIG. 5 is a flow chart illustrating a method 501 for modifying an image projection axis based on data received from a sensor 316 according to an embodiment. While the method 501 is described most specifically with respect to using an IMU such as the IMU 402 or FIG. 4, it may be similarly applied to receiving an image instability indication from other types of sensors.

In step 502, image movement or image displacement data (e.g. IMU data) is acquired. According to an embodiment, the image movement data is acquired once per frame. In alternative embodiments, it may be desirable to acquire image movement data at a higher or lower rate. According to some embodiments, the angle of the instrument with respect to local gravity is used to determine and maintain a projected image horizon. According to some embodiments, data corresponding to six axes comprising translation in three dimensions and rotation about three dimensions is collected. Proceeding to step 504, an image orientation corresponding to a projection axis is computed. The computed image or projection axis orientation may be determined on an absolute basis or a relative basis. When computed on a relative basis, it may be convenient to determine the change in projection axis relative to the prior video frame. As will be appreciated from the discussion below, it may also be advantageous to compute the change in projection axis relative to a series of video frames.

Proceeding to step 506, a modified projection axis is determined and the projection axis is modified to compensate for changes in image orientation. The modified projection axis may be determined as a function of the change in image orientation determined in step 504. Additionally, other parameters such as a gain value, an accumulated orientation change, and a change model parameter may be used to determine the modified projection axis. As will be understood from other discussion herein, there may be a number of ways to actualize a change in projection axis including, for example, actuating one or more optical elements, actuating a change in an image generator orientation, and modifying a display bitmap such as by changing the assignment of a display datum.

Proceeding to optional step 508, a gain input may be received. For example, a user may select a greater or lesser amount of stabilization. The gain input may further be used to turn image motion compensation on or off. According to another embodiment, the gain input may be determined automatically, for example by determining if excessive accumulation of change or if oscillations in the output control have occurred. Gain input may be used to maximize stability, change an accumulation factor, and/or reduce overcompensation, for example.

Proceeding to optional step 510, the projection axis change accumulation is updated to include the change in image orientation most recently determined in step 504 along with a history of changes previously determined. The change accumulation may for example be stored as a change history path across a number of dimensions corresponding to the dimensions acquired from the IMU. The projection axis change accumulation may further be analyzed to determine the nature of the accumulated changes to generate a change model parameter used in computing the image orientation the next time step 504 is executed. For example, when accumulated changes are determined to be substantially random, such as with the history of X-Z plane upward rotations being subsequently offset by X-Z plane downward rotations, etc., a change model parameter of “STATIC” may be generated. Alternatively, when accumulated changes are determined to be non-random, such as with a history of more-or-less successive positive rotation in the Z-Y plane, a change model parameter of “PAN RIGHT” may be generated. In the above example, a determined model “STATIC” may be used in step 506 to determine a modified projection axis that most closely matches the average projection axis over the past several frames. On the other hand, a determined model “PAN RIGHT” may be used in step 506 to determine a modified projection axis that most closely matches an extrapolated projection axis determined from a fit (such as a least squares fit) of the sequence of projection axes over the past several frames.

The use of axis change accumulation models may be used, for example, to allow a user holding a projection display to pan the displayed image smoothly around a room or hold the displayed image steady, each while maintaining a desirable amount of image stability. According to another example, a history of displacements may be fitted to a harmonic model and the next likely displacement extrapolated from the harmonic model. Projection axis compensation may thus be anticipatory to account for repeating patterns of displacement such as, for example, regular motions produced by the heartbeat or breathing of a user holding the projection display. These and other models may be used and combined.

The execution of the steps shown in FIG. 5 may optionally be done in a different order, including for example parallel or pipelined configurations. Processes may be added or deleted, such as to the extent controller, actuator, sensor, etc. bandwidth limitations may dictate.

Returning to FIG. 3, according to another embodiment, the sensor 316 may be operable to measure the relative position or relative motion of the screen, for example by measuring backscattered energy from the scanned beam 310, etc.

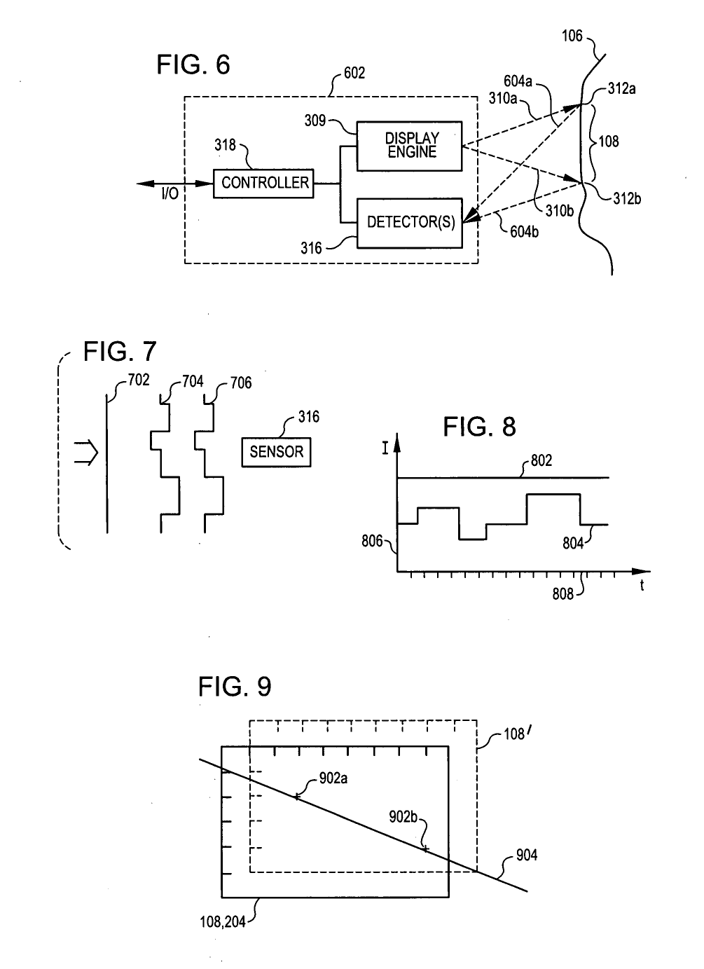

FIG. 6 is a block diagram of a projection display 602 that includes a detector 316, such as a backscattered light sensor, for measuring screen position according to an embodiment. As described above, to display an image, spots 312 on the projection surface 106 are illuminated by rays of light 310 projected from the display engine 309. In the case of a scanned beam display engine 309, the rays of light correspond to a beam that sequentially illuminates the spots.

While the beam 310 illuminates the spots, a portion of the illuminating light beam is reflected or scattered as scattered energy 604 according to the properties of the object or material at the locations of the spots. A portion of the scattered light energy 604 travels to one or more detectors 316 that receive the light and produce electrical signals corresponding to the amount of light energy received. The detectors 316 transmit a signal proportional to the amount of received light energy to the controller 318.

According to various embodiments, the measured light energy 604 may comprise visible light making up the displayed image that is scattered from the display surface 106. According to some embodiments, an additional wavelength of light may be formed and projected by the display engine or alternatively by a secondary illuminator (not shown). For example, infrared light may be shone upon the field-of-view. In this case, the detector 316 may be tuned to preferentially receive infrared light corresponding to the illumination wavelength.

According to another embodiment, collected light 604 may comprise ambient light scattered or transmitted by the projection surface 106. In the case where ambient light is used to measure the projection surface, the detector(s) 316 may include one or more filters, such as narrow band filters, to prevent projected light 310 scattered by the surface 106 from reaching the detector. For the example where the projected rays or beam 310 comprises 635 nanometer red light, a narrow band filter that removes 635 nanometer red light may be placed over the detector 316. According to some embodiments, preventing modulated projected image light from reaching the detector 316 may help to reduce processing bandwidth by making variations in received energy depend substantially entirely on variations in projection surface scattering properties rather than also upon variations in projected pixel intensity.

For embodiments where the received light energy 604 is scattered at least in-part from modulated projected image energy 310, the (known) projected image may be removed from the position parameter produced by the detector 316 and/or controller 318. For example the received energy may be divided by a multiple of the instantaneous brightness of each pixel and the resultant quotients used as an image corresponding to the projection surface.

Methods and apparatuses for removing the effects of the modulated projected image from light scattered by the field of view are disclosed in the U.S. patent application Ser. No. 11/284,043, entitled PROJECTION DISPLAY WITH SCREEN COMPENSATION, filed Nov. 21, 2005, hereby incorporated by reference.

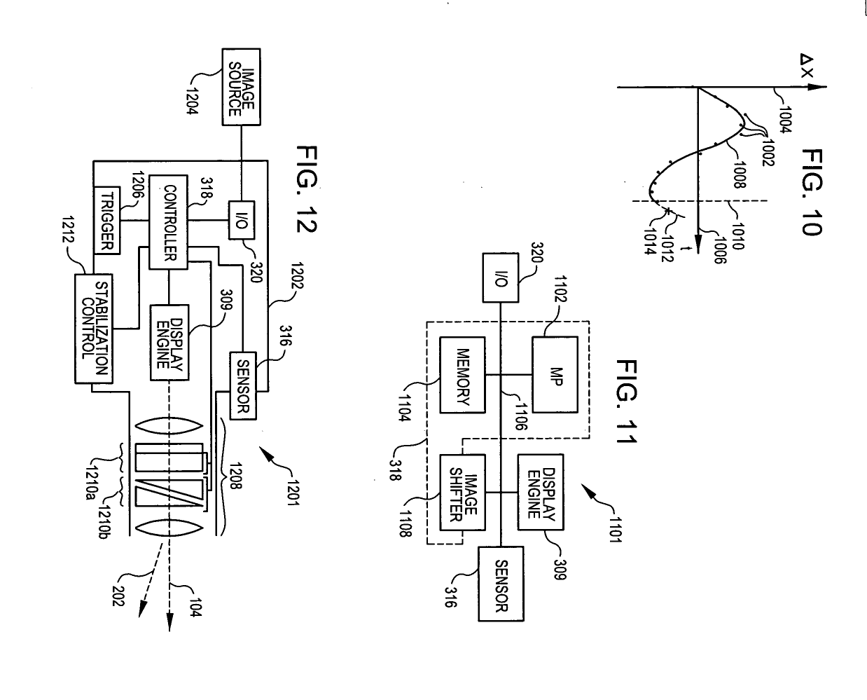

FIG. 7 is a diagram illustrating the detection of a relative location parameter for a projection surface using a radiation detector 316. Depending upon the particular embodiment, the radiation (e.g. light) detector 316 may include an imaging detector or a non-imaging detector 316. Uniform illumination 702 is shone upon a projection surface having varying scattering corresponding to 704. In FIG. 7 and similar figures, the vertical axis represents an arbitrary linear path across the projection surface such as line 904 in FIG. 9. The horizontal axis represents variations in optical properties along the path. Thus, uniform illumination intensity is illustrated as a straight vertical line 702. The projection surface has non-uniform scattering at some wavelength, hence the projection surface response 704 is represented by a line having varying positions on the horizontal axis. The uniform illumination 702 interacts with the non-uniform projection surface response 704 to produce a non-uniform scattered light signal 706 corresponding to the non-uniformities in the surface response. The sensor 316 is aligned to receive at least a portion of a signal corresponding to the non-uniform light 706 scattered by the projection surface.

According to one embodiment, the sensor 316 may be a focal plane detector such as a CCD array, CMOS array, or other technology such as a scanned photodiode, for example. The sensor 316 detects variations in the response signal 706 produced by the interaction of the illumination signal 702 and the screen response 704. While the screen response 704 may not be known directly, it may be inferred by the measured output video signal 706. Although there may be differences between the response signal 706 and the actual projection surface response 704, hereinafter they may be referred to synonymously for purposes of simplification and ease of understanding.

According to another embodiment, the sensor 316 of FIG. 6 may be a non-imaging detector. The operation of a non-imaging detector may be understood with reference to FIG. 8. FIG. 8 is a simplified diagram illustrating sequentially projecting pixels and measuring projection surface response or simultaneously projecting pixels and sequentially measuring projection surface response, according to embodiments. Sequential video projection and screen response values 802 and 804, respectively, are shown as intensities I on a power axis 806 vs. time shown on a time axis 808. Tick marks on the time axis represent periods during which a given pixel is displayed with an output power level 802. At the end of a pixel period, a next pixel, which may for example be a neighboring pixel, is illuminated. In this way, the screen is sequentially scanned, such as by a scanned beam display engine with a pixel light intensity shown by curve 802, or scanned by a swept aperture detector. In the simplified example of FIG. 8 the pixels each receive uniform illumination as indicated by the flat illumination power curve 802. Alternatively, illumination values may be varied according to a video bitmap and the response 804 compared to the known bitmap to determine the projection surface response. One way to determine the projection surface response is to divide a multiple of the detected response by the beam power corresponding to a received wavelength for each pixel.

FIG. 9 is a simplified diagram of projection surface showing the tracking of image position variations and compensation by varying the image projection axis. The area 108 represents an image projected onto a projection surface with the perimeter representing the display extent. Features 902a and 902b represent non-uniformities in the display surface that may be fall along a line 904. Line 904 indicates a correspondence to the display surface response curves 706 and 804 of FIGS. 7 and 8, respectively. For FIG. 9, the variations in screen uniformity are indicated by simplified locations 902a and 902b.

During a first video frame, an image is displayed on a surface having an extent 108. Tick marks on the left and upper edges of the video frame 108 represent pixel locations. Thus, during the projection of the video frame 108, feature 902a is at a location corresponding to pixel (3,2) and feature 902b is at a location corresponding to pixel (8,4). At a later instant, a video frame indicated 108′ is projected, the position of the edges of the frame having moved due to relative motion between the projection display and the display surface. By inspection of the Tick marks on the left and upper edges of video frame 108′, it may be seen that the features 902a and 902b have moved to locations corresponding to pixels (2,3) and (7,5), respectively.

Referring to the method of FIG. 5, it may be seen that during execution of step 504, the relative movement of sequential (though not necessarily immediately successive) video frames 108 and 108′ corresponds to a pixel movement of (−1,+1), calculated as (2,3)−(3,2)=(7,5)−(8,4)=(−1,+1). While the example of FIG. 9 indicates equivalent movement of the two points 902a and 902b between frames 108 and 108′, indicating no rotation of the projected image relative to the projection surface, the approaches shown herein may similarly be applied to compensation for movement that is expressed as apparent rotation of the projected image relative to the projection surface.

Referring again to FIG. 5, in step 506, (optionally assuming the projection axis change accumulation model is “STATIC”), the projection axis is modified by (+1,−1), calculated as OLD FRAME DATUM (0,0)−NEW FRAME DATUM (−1,+1)=(+1,−1).

The modified projection axis is modified by shifted leftward and downward by distances corresponding to one pixel distance as shown in FIG. 9. The third frame (assuming a projection axis update interval of one frame) is projected in an area 204, which corresponds to the first frame extent 108. Thus, the image region on the projection surface is stabilized and held substantially constant. To reduce the apparent image instability to a period less than the frame rate, the method of FIG. 5 may be run at a frequency higher than the frame rate, using features 902 distributed across the frame to update the frame location and modify the projection axis prior to completion of the frame.

According to another embodiment, the projection axis change accumulation may be modeled to determine a repeating function for anticipating future image movement and, hence, provide a projection axis modification that anticipates unintended motion. FIG. 10 illustrates the fitting of historical projection axis motion to a curve to derive a modified projection axis prior to projecting a frame or frame portion according to an embodiment.

A series of measured position variation values 1002, expressed as a parameter 1004 over a series of times 1006 are collected. The values 1002 may be one or a combination of measured axes and are here represented as Delta-X, corresponding to varying changes in position across the display surface along an axis corresponding to the horizontal display axis. Thus, the values 1002 represent a projection axis change history. Variations in position may tend to relate to periodic fluctuations such as heartbeats (if the projection display is hand-held) and other internal or external influences. For such periodic fluctuations, the projection axis change history may be fitted to a periodic function 1008 that may, for example contain sine and cosine components. While the function 1008 is indicated for simplicity as a simple sine function, it may of course contain several terms such as several harmonic components with coefficients that describe various functions such as, for example, functions resembling triangle, sawtooth, and other more complex functions. Furthermore, periodic functions 1008 may be stored separately for various axes of motion or may be stored as interrelated functions across a plurality of axes, such as for example a rotated sine-cosine function.

Function 1008 represents one type of projection axis change model according to an embodiment, such as a model determined in optional step 510 of FIG. 5. Assuming time progresses from left to right along axis 1006, there is a point 1010 representing the current time or the most recent update. According to an embodiment, the function 1008 may be extended into the future along a curve 1012. Accordingly, the next frame may be projected along a modified projection axis corresponding to a fitted value 1014 as indicated.

Modification of the projection axis may be accomplished in a number of ways according to various embodiments.

FIG. 11 is a simplified block diagram of some relevant subsystems of a projection display 1101 having image stability compensation capability. A controller 318 includes a microprocessor 1102 and memory 1104, the memory 1104 typically configured to include a frame buffer, coupled to each other and to other system components over a bus 1106. An interface 320, which may be configured as part of the controller 318 is operable to receive a still or video image from an image source (not shown). A display engine 309 is operable to produce a projection display. A sensor 316 is operable to detect data corresponding to image instability such as image shake. An image shifter 1108, shown partly within the controller 318 is operable to determine and/or actuate a change in an image projection axis. The nature of the image shifter 1108, according to various embodiments, may make it a portion of the controller 318, a separate subsystem, or it may be distributed between the controller 318 and other subsystems.

FIG. 12 is a diagram of a projection display 1201 using actuated adaptive optics to vary the projection axis according to an embodiment. The projection display 1201 includes a housing 1202 holding a controller 318 configured to drive a display engine 309 responsive to video data received from an image source 1204 through an interface 320. An optional trigger 1206 is operable to command the controller 318 to drive the display engine 309 to project an image along a projection axis 104 (and/or modified projection axis 202) through a lens assembly 1208. The lens assembly 1208 includes respective X-axis (horizontal) and Y-axis (vertical) light deflectors 1210a and 1210b. According to alternative embodiments, the light deflectors 1210a and 1210b may be combined into a single element or divided among additional elements.

A sensor 316 is coupled to the controller 318 to provide projected image instability data. While the sensor 316 is indicated as being mounted on an external surface of the housing 1202, it may be arranged in other locations according to the embodiment. An optional stabilization control selector 1212 may be configured to accept user inputs regarding the amount and type of image stabilization to be performed. For example, the stabilization control selector 1212 may comprise a simple on/off switch, may include a gain selector, or may be used to select a mode of stabilization.

According to feedback from the sensor 316, and responsive to the optional stabilization control selector 1212, the controller is operable to actuate the X-axis and Y-axis light deflectors 1210a and 1210b to produce a modified image projection axis 202. The modified image projection axis may be a variable axis whose amount of deflection is operable to reduce image-shake and improve image stability.

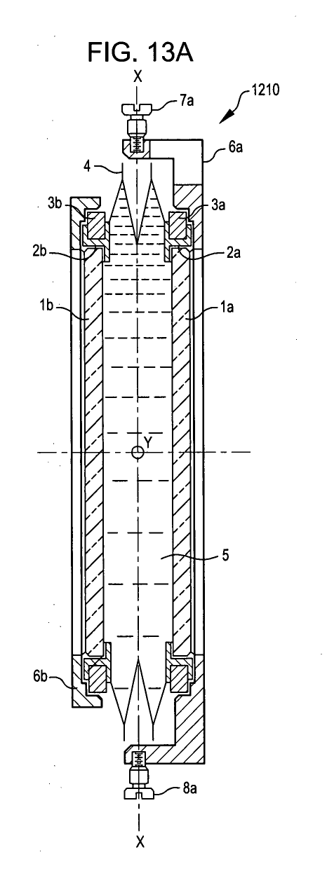

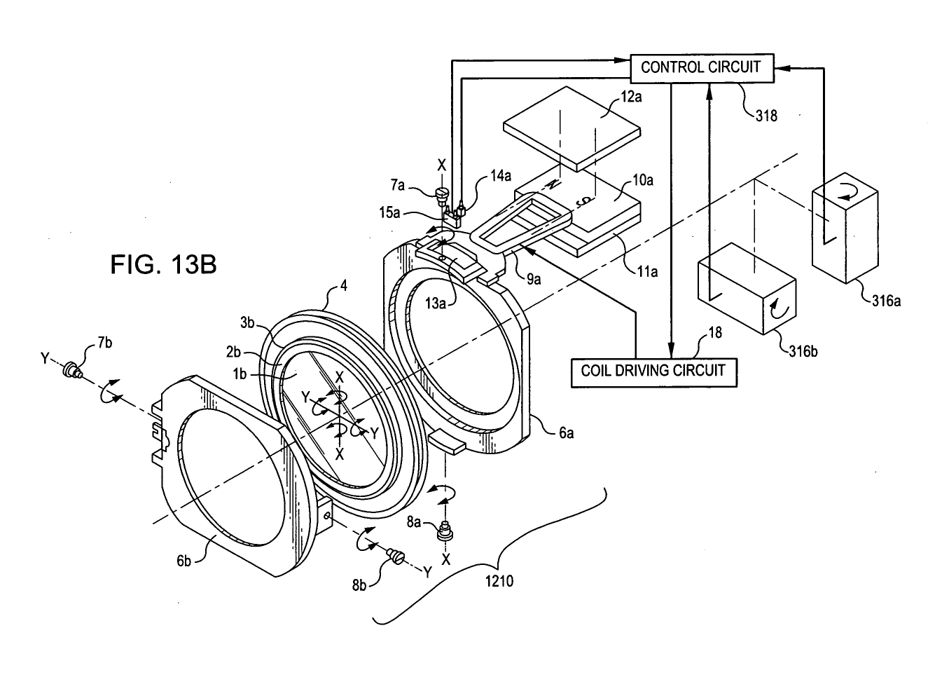

FIG. 13A is a cross-sectional diagram and FIG. 13B is an exploded diagram of an integrated X-Y light deflector 1210 according to an embodiment. The features and operation of FIGS. 13A and 13B are described more fully in U.S. Pat. No. 5,715,086, entitled IMAGE SHAKE CORRECTING DEVICE, issued Feb. 3, 1998 to Noguchi et al., hereby incorporated by reference.

Referring to FIGS. 13A and 13B, a variable angle prism includes transparent plates 1a and 1b made of glass, plastic or the like, frames 2a and 2b to which the respective transparent plates la and lb are bonded, reinforcing ring 3a and 3b for the respective frames 2a and 2b, a bellows-like film 4 for connecting the frames 2a and 2b and a hermetically enclosed transparent liquid 5 of high refractive index. The variable angle prism is clamped between frames 6a and 6b. The frames 6a and 6b are respectively supported by supporting pins 7a, 8a and 7b, 8b in such a manner as to be able to swing around a yaw axis (X-X) and a pitch axis (Y-Y), and the supporting pins 7a, 8a and 7b, 8b are fastened to a system fixing member such as using screws or other fastening method. The yaw axis (X-X) and the pitch axis (Y-Y) extend orthogonally to each other in the central plane or approximately central plane (hereinafter referred to as “substantially central plane”) of the variable angle prism.

A flat coil 9a is fixed to one end of the frame 6a located on a rear side, and a permanent magnet 10a and a yoke 11a and a yoke 12a are disposed in opposition to both faces of the flat coil 9a, thereby forming a closed magnetic circuit. A slit plate 13a having a slit is mounted on the frame 6a, and a light emitting element 14a and a light receiving element 15a are disposed on the opposite sides of the slit plate 13a so that a light beam emitted from the light emitting element 14a passes through the slit and illuminates the light receiving element 15a. The light emitting element 14a may be an infrared ray emitting device such as an infrared LED, and the light receiving element 15a may be a photoelectric conversion device whose output level varies depending on the position on the element 15a where a beam spot is received. If the slit travels according to a swinging motion of the frame 6a between the light emitting element 14a and the light receiving element 15a (which are fixed to the system fixing member), the position of the beam spot on the light receiving element 15a varies correspondingly, whereby the angle of the swinging motion of the frame 6a can be detected and converted to an electrical signal.

Image-shake detectors 316a and 316b are mounted on the system fixing member for detecting image shakes relative to yaw- and pitch-axis directions, respectively. Each of the image-shake detectors 16a and 16b is an angular velocity sensor, such as a vibration gyroscope which detects an angular velocity by utilizing the Coriolis force.

Although not shown, on the pitch-axis side of the variable angle prism assembly there are likewise provided electromagnetic driving force generating means made up of a flat coil 9b, a permanent magnet 10b and yokes 11b, 12b and means for detecting the swinging angle of the frame 6b made up of a slit plate 13b as well as a light emitting element 14b and a light receiving element 15b. This pitch-axis side arrangement functions similarly to the above-described yaw-axis side arrangement.

An image-shake correcting operation carried out by the above-described arrangement will be sequentially described below. During image projection, if a motion is applied to the projection display by a cause such as a vibration of a hand holding the projection display, the image-shake detectors 16a and 16b supply signals indicative of their respective angular velocities to a control circuit 318. The control circuit 318 calculates by appropriate computational processing the amount of displacement of the apex angle of the variable angle prism that is required to correct an image shake due to the motion.

In the meantime, variations of the apex angle of the variable angle prism relative to the respective yaw- and pitch-axis directions are detected on the basis of the movements of the positions of beam spots formed on the light receiving surfaces of the corresponding light receiving elements 15a and 15b, the beam spots being respectively formed by light beams which are emitted by the light emitting elements 14a and 14b, pass through the slits of the slit plates 13a and 13b mounted on the frames 6a and 6b and illuminate the light receiving elements 15a and 15b. The light receiving elements 15a and 15b transmit signals to the control circuit 318 corresponding to the amount of the movement of the respective beam spots, i.e., the magnitudes of the variations of the apex angle of the variable angle prism relative to the respective yaw- and pitch-axis directions.

The control circuit 318 computes the difference between the magnitude of a target apex angle obtained from the calculated amount of the displacement described previously and the actual magnitude of the apex angle of the variable angle prism obtained at this point in time, and transmits the difference to the coil driving circuit 18 as a coil drive instruction signal. The coil driving circuit 18 supplies a driving current according to the coil drive instruction signal to the coils 9a and 9b, thereby generating driving forces due to electromagnetic forces, respective, between the coil 9a and the permanent magnet 10a and between the coil 9b and the permanent magnet 10b. The opposite surfaces of the variable angle prism swing around the yaw axis X-X and the pitch axis Y-Y, respectively, so that the apex angle coincides with the target apex angle.

In other words, the image-shake correcting device according to the embodiment is arranged to perform image-shake correcting control by means of a feedback control system in which the value of a target apex angle of the variable angle prism, which is computed for the purpose of correcting an image shake, is employed as a reference signal and the value of an actual apex angle obtained at that point in time is employed as a feedback signal.

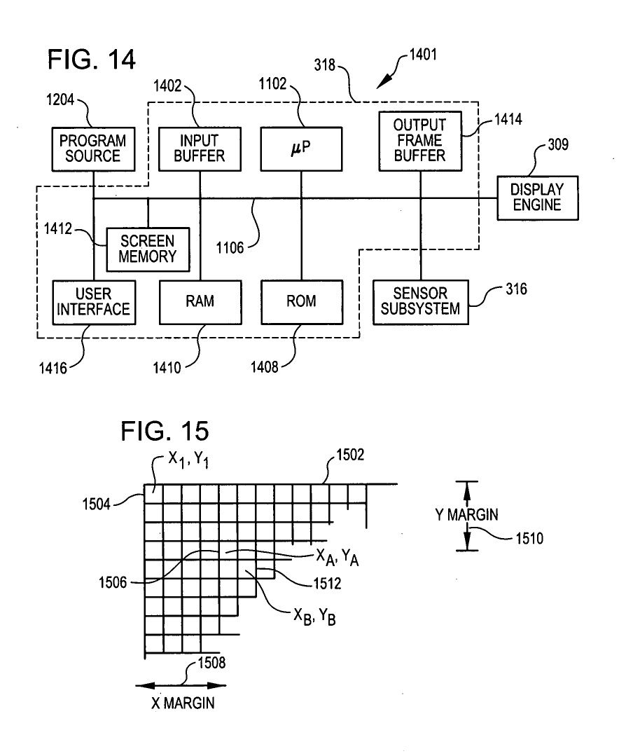

FIG. 14 is a block diagram of a projection display 1401 operable to compensate for image shake using pixel shifting according to an embodiment. FIG. 14 illustrates the relationship of major components of an image stabilizing display controller 318 and peripheral devices including the program source 1204, display engine 309, and sensor subsystem 316 used to form an image-stabilizing display system 1401. The memory 1104 is shown as discrete or partitioned allocations including an input buffer 1402, read-only memory 1408 (such as mask ROM, PROM, EPROM, flash memory, EEPROM, static RAM, etc.), random-access memory (RAM) or workspace 1410, screen memory 1412, and an output frame buffer 1414. The embodiment of FIG. 19 is a relatively conventional programmable microprocessor-based system where successive video frames are received from the video source 1204 and saved in an input buffer 1402 by a microcontroller 1102 operating over a conventional bus 1106. The sensor subsystem 316 measures orientation data such as, for example, the pattern of light scattered by the projection surface as described above. The microprocessor 1102, which reads its program instructions from ROM 1408, reads the pattern returned from the sensor subsystem 316 into RAM and compares the relative position of features against the screen memory 1412 from the previous frame. The microprocessor calculates a variation in apparent pixel position relative to the projection surface and determines X and Y offsets corresponding to the change in position, such as according to the method of FIG. 5, optionally using saved parameters. The current projection surface map is written to the screen memory 1412, or alternatively a pointer is updated to the current projection surface map, and optionally the projection axis history is updated, new data used to recomputed motion models, etc.

The microprocessor 1102 reads the frame out of the input buffer 1402 and writes it to the output buffer 1414 using offset pixel locations corresponding to the X and Y offsets. The microprocessor then writes data from the output buffer 1414 to the display engine 309 to project the frame received from the program source 1204 onto the projection surface (not shown). Because of the offset pixel locations incorporated into the bitmap in the output frame buffer 1404, the image may be projected along a projection axis that is compensated according to the relative movement between the projection display 1401 and the projection surface sensed by the sensor subsystem 316.

In an alternative embodiment, the determined pixel shift values may be used during the readout of the image buffer to the display engine to offset the pixels rather than actually writing the pixels to compensated memory locations. Either approach may for example be embodied in a state machine.

The contents of the output frame buffer 1414 are transmitted to the display engine 309, which contains digital-to-analog converters, output amplifiers, light sources, one or more pixel modulators (such as a beam scanner, for example), and appropriate optics to display an image on a projection surface (not shown). A user interface 1416 receives user commands that, among other things, affect the properties of the displayed image. Examples of user control include motion compensation on/off, motion compensation gain, motion model selection, etc.

As was indicated above, alternative non-imaging light detectors such as PIN photodiodes, PMT or APD type detectors may be used. Additionally, detector types may be mixed according to application requirements. Also, it is possible to use a number of channels fewer than the number of output channels. For example a single detector may be used. In such a case, an unfiltered detector may be used in conjunction with sequential illumination of individual color channel components of the pixels on the display surface. For example, red, then green, then blue light may illuminate a pixel with the detector response synchronized to the instantaneous color channel output. Alternatively, a detector or detectors may be used to monitor a luminance signal and projection screen illumination compensation dealt with by dividing the detected signal by the luminance value of the corresponding pixel. In such a case, it may be useful to use a green filter in conjunction with the detector, green being the color channel most associated with the luminance response. Alternatively, no filter may be used and the overall amount of scattering by the display surface monitored.

FIG. 15 is a graphical depiction of a portion of a bitmap memory showing offset pixel locations according to an embodiment. A bitmap memory 1502 includes memory locations X, Y corresponding to the range of pixel locations the display engine is capable of projecting. The upper left possible pixel 1504 is shown as X₁, Y₁. Nominally, the image extent may be set to a smaller range of pixel values than what the display engine is capable of producing, the extra range of pixel values being “held in reserve” to allow for moving the projected image across the bitmap to compensate for image shake. The upper left nominally projected pixel 1506 is designated (X_{A}, Y_{A}). The pixel 1506 corresponds to a location that produces a projection axis directed in a nominal direction, given no image shake. The pixel 1506 is offset horizontally from the pixel 1504 by an XMARGIN value 1508 and offset vertically from pixel 1504 by a YMARGIN value 1510. Thus, the amount of leftward horizontal movement allowed for compensating for image shake (assuming no image truncation is to occur) is a number of pixels equal to XMARGIN and the amount of upward vertical movement allowed is YMARGIN. Assuming a similar margin on the right and bottom edges of the bitmap, similar capacity is available respectively for rightward horizontal and downward vertical movement.

For an illustrative situation where the projection axis has (at least theoretically) shifted upward by one pixel and leftward by one pixel due to shake, the controller shifts the output buffer such that the pixel 1512, designated (X_{B}, Y_{B}), is selected to display the upper left pixel in the image. Thus, the projection axis is shifted downward and to the right to compensate for the physical movement of the projection display upward and to the left.

According to some embodiments, the margin values (e.g. XMARGIN and YMARGIN) may be determined according to a selected gain and/or a detected amount of image shake. That is, larger amplitude shake may be accommodated by projecting a lower resolution image that provides greater margins at the edge of the display engine's available field of view.

In some applications, image shake may result in large translation or rotation would nominally consume all of the available margin (e.g. XMARGIN and YMARGIN). According to some embodiments, the controller may strike a balance, for example by compensating for some or all of the image instability by truncating the projected image, by modifying gain of the stabilization function, by providing a variable gain stabilization function, by modifying display resolution, etc.

According to some applications, the image is selected to be larger than the field of view of the display engine. That is, the XMARGIN and YMARGIN margins may be negative. In such a case, the user may pan the display across the larger image space with the controller progressively revealing additional display space. The central image may thus remain stable with the image shake alternately revealing additional information around the periphery of the central area. Such embodiments may allow for very large display space, large image magnification, etc.

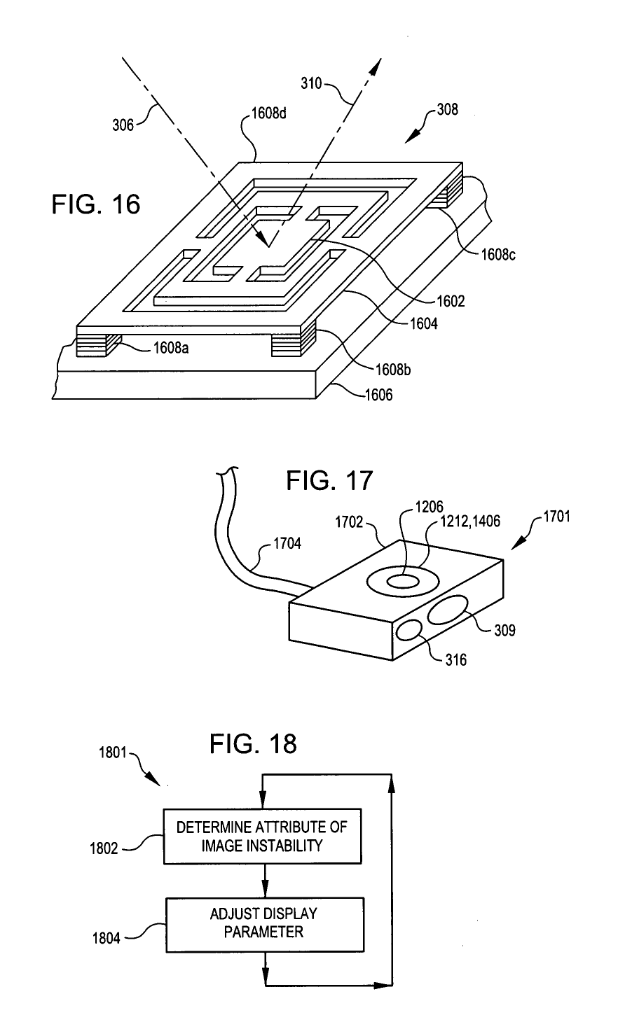

An alternative approach for providing variable projection axes is illustrated in FIG. 16. FIG. 16 illustrates a beam scanner 308 capable of being tilted to modify the projection axis. A received beam 306 is reflected by a scan mirror 1602 in a two-dimensional pattern. The scan mirror with actuators is supported by a frame 1604. The frame 1604 is supported on a stable substrate 1606 via projection axis actuators 1608. As shown, projection actuators 1608 are comprised of piezo-electric stacks that may be set to selected heights. According to the desired projection axis offset, the piezo-electric stacks 1608a-d are actuated to tilt the frame 1604 such that the normal direction of the plane of the frame 1604 is set to one half the projection axis offset from nominal. The reflection multiplication thus sets the mean angle of the scanned beam 310 to the desired projection axis. The relative lengths of the piezo stacks 1608 may be selected to maintain desired optical path lengths for the beams 306 and 310.

According to alternative embodiments, a larger portion of or the entire scanned beam display engine may be tilted or shifted relative to the housing. According to still other alternative embodiments, all or portions of alternative technology display engines (LCOS, DMD, etc.) may be tilted or shifted to achieve a desired projection axis.

FIG. 17 is a perspective drawing of an illustrative portable projection system 1701 with motion compensation, according to an embodiment. Housing 1702 of the display 1701 houses a display engine 309, which may for example be a scanned beam display, and a sensor 316 aligned to receive scattered light from a projection surface. Sensor 316 may for example be a non-imaging detector system.

Several types of detectors 316 may be appropriate, depending upon the application or configuration. For example, in one embodiment, the detector may include a PIN photodiode connected to an amplifier and digitizer. In this configuration, beam position information is retrieved from the scanner or, alternatively, from optical mechanisms. In the case of a multi-color projection display, the detector 316 may comprise splitting and filtering to separate the scattered light into its component parts prior to detection. As alternatives to PIN photodiodes, avalanche photodiodes (APDs) or photomultiplier tubes (PMTs) may be preferred for certain applications, particularly low light applications.

In various approaches, photodetectors such as PIN photodiodes, APDs, and PMTs may be arranged to stare at the entire projection screen, stare at a portion of the projection screen, collect light retro-collectively, or collect light confocally, depending upon the application. In some embodiments, the photodetector system 316 collects light through filters to eliminate much of the ambient light.

The display 1701 receives video signals over a cable 1704, such as a Firewire, USB, or other conventional display cable. Display 1701 may transmit detected motion or apparent projection surface position changes up the cable 1704 to a host computer. The host computer may apply motion compensation to the image prior to sending it to the portable display 1701. The housing 1702 may be adapted to being held in the hand of a user for display to a group of viewers. A trigger 1206 and user input 1212, 1406, which may for example comprise a button, a scroll wheel, etc., may be placed for access to display control functions by the user.

Embodiments of the display of FIG. 17 may comprise a motion-compensating projection display where the display engine 309, sensor 316, trigger 1206, and user interface 1212, 1406 are in a housing 1702. A program source 1204 (not shown) and optionally a controller 318 (not shown) may be in a different housing, the two housings being coupled through an interface such as a cable 1704. For example, as described above the program source and controller may be included in a separate image source such as a computer, a television receiver, a gauge driver, etc. In such a case, the interface 1704 may be a bi-directional interface configured to transmit a (motion compensated) image from the separate image source (not shown) to the projection display 1701, and to transmit signals corresponding to detected motion from the projection display 1701 to the separate image source. Calculations, control functions, etc. described herein may be computed in the separate image source and applied to the image signal prior to transmission to the portable display 1701.

Alternatively, the display 1701 of FIG. 17 may include self-contained control for motion compensation.

While the hand-held projection display of FIG. 17 depicts one illustrative embodiment, a number of alternative embodiments are possible. For example, a projection display may be used as heads-up display, such as in a vehicle, and image instabilities resulting from road or air turbulence, high g-loading, inexpensive mounting, etc. may be compensated for. In another embodiment, a projection display may be of a type that is mounted on a table or ceiling and image instability arising from vibration of the projection display responsive to the movement of people through the room, or the movement of a display screen relative to a solidly fixed display may be compensated for. Alternatively, the projection display may comprise a display in a portable device such as a cellular telephone for example that may be prone to effects such as color sequential breakup or other image degradation. Modification of the projection axis to compensate for image instability may include maintaining a relatively stable axis relative to a viewer's eyes, even when both the viewer and the portable device are in motion.

As may be readily appreciated, the control systems described in various figures may include a number of different hardware embodiments including but not limited to a programmable microprocessor, a gate array, an FPGA, an ASIC, a DSP, discrete hardware, or combinations thereof. The functions may further be embedded in a system that executes additional functions or may be spread across a plurality of subsystems.

FIG. 18 is a flow chart showing a method 1801 for making adjustments to projection display and/or image parameters responsive to image instability according to an embodiment. In step 1802, a controller determines an attribute of image instability. For example, an attribute determined in step 1802 may be a magnitude of image shake. Proceeding to step 1804, the controller may adjust one or more display and/or image parameters responsive to the attribute determined in step 1802. An example of a modified display parameter may be image resolution. That is, according to an embodiment, the resolution of the displayed image may be reduced when it is determined that the magnitude of image shake makes the image unreadable or aesthetically not pleasing. The projection of a lower resolution image a given instability attribute (e.g. magnitude) may make image shake less noticeable and therefore less objectionable to the viewer.

The method of FIG. 18 may be used for example in lieu of varying the projection axis of an image or may be used when the magnitude, frequency, etc. of image shake is beyond the range of what may be corrected using other image stabilization techniques. As may be seen, the process 1801 may be repeated periodically. This may be used for example to dynamically adjust the display parameters in response to changing image projection instability.

The preceding overview, brief description of the drawings, and detailed description describe illustrative embodiments according to the present invention in a manner intended to foster ease of understanding by the reader. Other structures, methods, and equivalents may be within the scope of the invention. The scope of the invention described herein shall be limited only by the claims.

What is claimed is:

1. A projection display comprising:
a display engine operable to project an image;
a sensor operable to generate a signal responsive to a motion; and
a controller operable receive the signal from the sensor and responsively drive the display engine to project an image that includes compensation for the motion.

2. The projection display of claim 1 wherein the image the compensation for the motion includes selecting an image resolution that corresponds to the motion.

3. The projection display of claim 2 wherein the controller is operable to set image resolution lower when the amount of motion is larger.

4. The projection display of claim 1 wherein the display engine is operable to project the image along a plurality of axes and the image that compensates for the motion is projected along a projection axis that improves the stability of the projected image location.

5. The projection display of claim 4 further comprising an actuated optical element and wherein the projection display is operable to select from among the plurality of image projection axes by actuating the optical element.

6. The projection display of claim 5 wherein the actuated optical element includes an optical axis deflector.

7. The projection display of claim 4 wherein the controller is operable to select from a plurality of bitmapped display regions corresponding to a plurality of projection axes.

8. The projection display of claim 4 wherein the display engine includes an actuator operable to select a plurality of positions corresponding to a plurality of projection axes.

9. The projection display of claim 8 wherein the actuator is operable to reposition a component of the display engine.

10. The projection display of claim 1 wherein the sensor includes a motion sensor.

11. The projection display of claim 1 wherein the sensor includes an optical sensor.

12. The projection display of claim 11 wherein the optical sensor is operable to detect the position of a projected image relative to a projection surface.

13. The projection display of claim 1 wherein the controller is further operable to compute a model of a sequence of detected motions and drive the display engine according to the model.

14. The projection display of claim 1 wherein the display engine includes a scanned beam display engine.

15. The projection display of claim 1 further comprising a hand-supportable housing.

16. The projection display of claim 15 further comprising at least one user-accessible control.

17. The projection display of claim 1 further comprising an image source.

18. The projection display of claim 17 further comprising a hand-supportable housing and where the display engine and the sensor are coupled to the hand-supportable housing and the controller is coupled to the image source.

19. A method of compensating for image shake in a projection display comprising the steps of:
detecting image shake; and
projecting an image that compensates for the image shake.

20. The method of compensating for image shake in a projection display of claim 19 wherein projecting an image that compensates for the image shake includes selecting an image resolution that corresponds to the image shake.

21. The method of compensating for image shake in a projection display of claim 20 wherein projecting an image that compensates for the image shake includes setting an image resolution lower when the amount of image shake is larger.

22. The method of compensating for image shake in a projection display of claim 19 wherein projecting an image that compensates for the image shake includes projecting the image along a projection axis that improves the stability of the projected image location.

23. The method of compensating for image shake in a projection display of claim 22 wherein projecting the image along a projection axis that improves the stability of the projected image location includes selecting from among a plurality of image projection axes by actuating an optical element.

24. The method of compensating for image shake in a projection display of claim 23 wherein actuating an optical element includes actuating an optical axis deflector.

25. The method of compensating for image shake in a projection display of claim 22 wherein projecting the image along a projection axis that improves the stability of the projected image location includes selecting from among a plurality of bitmapped display regions corresponding to a plurality of projection axes.

26. The method of compensating for image shake in a projection display of claim 22 wherein projecting the image along a projection axis that improves the stability of the projected image location includes actuating at least a portion of a display engine to one of a plurality of positions corresponding to a plurality of projection axes.

27. The method of compensating for image shake in a projection display of claim 26 wherein actuating at least a portion of a display engine is operable to reposition a component of the display engine.

28. The method of compensating for image shake in a projection display of claim 19 wherein detecting image shake includes receiving a signal from a motion sensor.

29. The method of compensating for image shake in a projection display of claim 19 wherein detecting image shake includes receiving a signal from an optical sensor.

30. The method of compensating for image shake in a projection display of claim 29 wherein the signal from the optical sensor corresponds to the position of a projected image relative to a projection surface.

31. The method of compensating for image shake in a projection display of claim 19 further comprising the step of computing a model of a sequence of detected motions and the step of projecting an image that compensates for the image shake includes driving a display engine according to the model.

32. The method of compensating for image shake in a projection display of claim 19 wherein the step of projecting an image that compensates for the image shake includes driving a display engine.

33. The method of compensating for image shake in a projection display of claim 32 wherein driving the display engine includes driving a scanned beam display engine.

34. The method of compensating for image shake in a projection display of claim 19 further comprising projecting the image from a hand-supportable housing.

35. The method of compensating for image shake in a projection display of claim 34 further comprising receiving at least one user input from a user-accessible control.

36. The method of compensating for image shake in a projection display of claim 19 further comprising receiving an image from an image source.

37. The method of compensating for image shake in a projection display of claim 36 further comprising the steps of:
sending a parameter corresponding to the detected image shake to the image source; and
receiving data from the image source that compensates for the image shake.

38. A system comprising:
a display operable to display an image; and
a motion detection circuit operable to stabilize the image.

39. The system of claim 38 wherein the display is configured as a heads-up display.

40. The system of claim 39 further comprising a vehicle instrumentation system operable to provide data to the heads-up display.

41. The system of claim 38 wherein the display is configured as a portable electronic device display.

42. The system of claim 41 wherein the portable electronic device includes a cellular telephone.
